(19) United States
(12) Patent Application Publication
(10) Pub. No.: US 2024/0137811 A1
(43) Pub. Date: Apr. 25, 2024

(54) CONTROL SYSTEM, CONTROL METHOD, CONTROLLER, AND PROGRAM

(71) Applicant: NIPPON TELEGRAPH AND TELEPHONE CORPORATION, Tokyo (JP)

(72) Inventors: Yuki SAKAUE, Musashino-shi, Tokyo (JP); Katsuya MINAMI, Musashino-shi, Tokyo (JP); Tatsuya FUKUI, Musashino-shi, Tokyo (JP); Ryohei TSUGAMI, Musashino-shi, Tokyo (JP)

(73) Assignee: NIPPON TELEGRAPH AND TELEPHONE CORPORATION, Tokyo (JP)

(21) Appl. No.: 18/277,745

(22) PCT Filed: Mar. 14, 2021
(86) PCT No.: PCT/JP2021/010311

§ 371 Date: Aug. 16, 2023

(51) Int. Cl. H04W 28/12; H04W 48/02; H04W 88/12

(52) U.S. Cl. CPC H04W 28/12; H04W 48/02; H04W 88/12

(57) ABSTRACT

An object of the present disclosure is to perform appropriate communication quality control even when a terminal out of management of a controller is connected to an access point.

The present disclosure is a control system for controlling traffic of a wireless network, the control system including: a terminal and an access point that mutually transmit a packet via the wireless network; and a controller that performs transmission control with respect to the terminal and the access point, in which the controller notifies the access point of information of a terminal under management of the own device, and the access point collates information of the terminal a notification of which has been given with information of a terminal connected to the own device, and suppresses notification of transmission permission to an unmanaged terminal different from a terminal under management of the controller.

### TECHNICAL FIELD

The present disclosure relates to a control system, a control method, a controller, and a program for allocating a communication band in an access network.

### BACKGROUND ART

In recent years, studies have been made to accommodate a plurality of services and applications having various network requirements on the same network infrastructure. For this purpose, it is necessary to ensure quality required by each service and application accommodated in the same NW in an End-End section of “terminal to terminal” or “terminal to application server”.

The network End-End can be divided into wireless and wired sections. Among them, in the wireless section, there is a priority control function called Enhanced Distributed Channel Access (EDCA) of IEEE 802.11 as an existing technology (Non Patent Literature 1 and 2).

EDCA is control on a terminal (destination) basis, and there is a problem that it is difficult to perform control on a traffic flow basis so as to enable quality control on a service and application basis.

As a solution to this problem, it is conceivable that a controller allocates a communication band on the basis of a notification of a packet amount from a terminal. However, when a terminal managed by the controller and a terminal out of management are connected to the same access point, even when the terminal under the management transmits a packet according to a scheduler, the terminal out of the management generates a packet collision in the wireless network, so that the packet cannot be transmitted according to the scheduler.

### CITATION LIST

### Non Patent Literature

Non Patent Literature 1: IEEE 802.11e-2005—IEEE Standard for Information technology—Local and metropolitan area networks—Specific requirements—Part 11: Wireless LAN Medium Access Control (MAC) and Physical Layer (PHY) Specifications—Amendment 8: Medium Access Control (MAC) Quality of Service Enhancements
Non Patent Literature 2: IEEE802.11e—QoS Enhanced Wireless LAN Standard, The journal of the Institute of Image Information and Television Engineers Vol. 57, No. 11 (2003)

### SUMMARY OF INVENTION

### Technical Problem

An object of the present disclosure is to perform appropriate communication quality control even when a terminal out of management of a controller is connected to an access point.

### Solution to Problem

A control system and control method of the present disclosure is
a control system and control method for controlling traffic of a wireless network, the control system and control method being transmission control performed by a controller with respect to a terminal and an access point that mutually transmit a packet via the wireless network, in which
the controller notifies the access point of information of a terminal under management of own device, and
the access point
collates information of the terminal a notification of which has been given with information of a terminal connected to the own device, and
suppresses notification of transmission permission to an unmanaged terminal different from a terminal under management of the controller.

A controller of the present disclosure is
a controller for controlling traffic of a wireless network,
the controller being a device that performs transmission control with respect to a terminal and an access point that mutually transmit a packet via the wireless network, in which
the controller notifies the access point of information of a terminal under management of own device, and
causes the access point to suppress notification of transmission permission to an unmanaged terminal different from a terminal under management of the controller.

The present disclosure is a program for causing a computer to function as the controller. The controller can also be implemented with a computer and a program, and the program can be recorded on a recording medium or be provided through a network.

### Advantageous Effects of Invention

According to the present disclosure, even when a terminal out of management of a controller is connected to an access point, appropriate communication quality control can be performed.

### BRIEF DESCRIPTION OF DRAWINGS

FIG. 1 illustrates an example of a basic configuration of the present disclosure.

FIG. 2 illustrates an example of a system configuration according to an embodiment.

FIG. 3 is an example of information held in a database unit of a controller.

FIG. 4 is an example of information held in a database unit of an access point.

FIG. 5 illustrates an example of an operation of update of the database unit of the access point.

FIG. 6 illustrates an example of scheduling timing of the embodiment.

FIG. 7 is an example of information held in the database unit of the controller.

FIG. 8 is an example of information held in the database unit of the access point.

FIG. 9 illustrates an example of an operation of update of the database unit of the access point.

FIG. 10 illustrates an example of an operation when there is a transmission request from a terminal to an access point.

FIG. 11 is an example of information held in the database unit of the controller.

FIG. 12 illustrates an example of an operation of a control system of an embodiment.

### DESCRIPTION OF EMBODIMENTS

Hereinafter, an embodiment of the present disclosure will be described in detail with reference to the drawings. Note that the present disclosure is not limited to the embodiment described below. Such an implementation example is merely an example, and the present disclosure can be carried out in forms with various modifications and improvements based on the knowledge of a person skilled in the art. Note that components having the same reference numerals in the present specification and the drawings denote the same components.

(Basic Configuration)

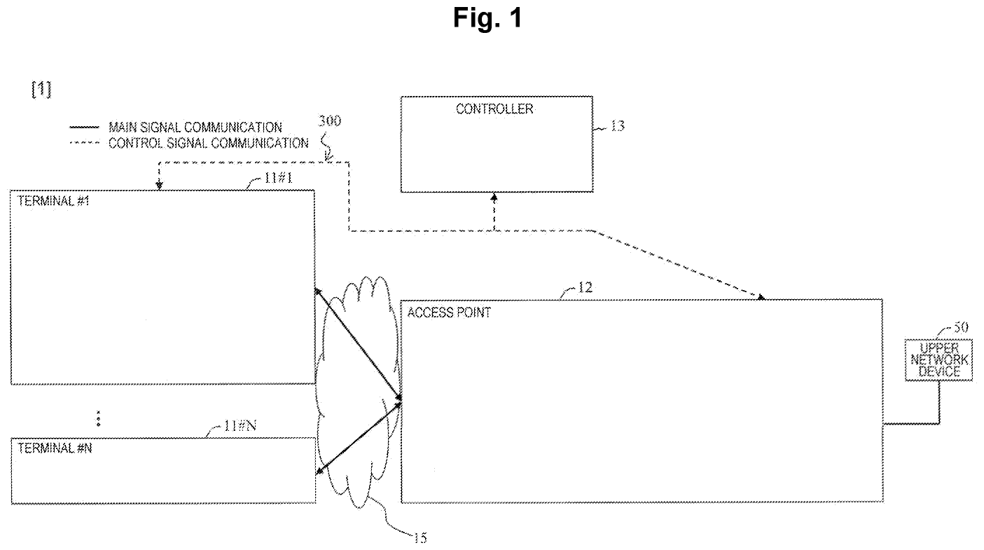

First, a basic configuration of a control system of the present embodiment will be described. FIG. 1 is a diagram describing a control system 300 of the present embodiment.

The control system 300 is a control system that controls traffic of a wireless network 15, and includes:
a terminal 11 and an access point 12 that mutually transmit a packet via the wireless network 15; and
a controller 13 that performs transmission control with respect to the terminal 11 and the access point 12.

In the terminal 11 connected to the access point 12, there are a terminal 11 managed by the controller 13 (hereinafter, referred to as a “managed terminal”) and a terminal 11 not managed by the controller 13 (hereinafter, referred to as a “unmanaged terminal”).

The control system 300 of the present disclosure is
a network including the access point 12 and the controller 13 that controls packet transmission of the terminal 11 to the access point 12,
the controller 13 notifies the access point 12 of information of a managed terminal of the own device, and
the access point 12 collates the information of the managed terminal a notification of which has been given, with information of the terminal 11 connected to the own device, and does not transmit a transmission permission notification (in a predetermined time zone) to the unmanaged terminal of the controller 13.

### First Embodiment

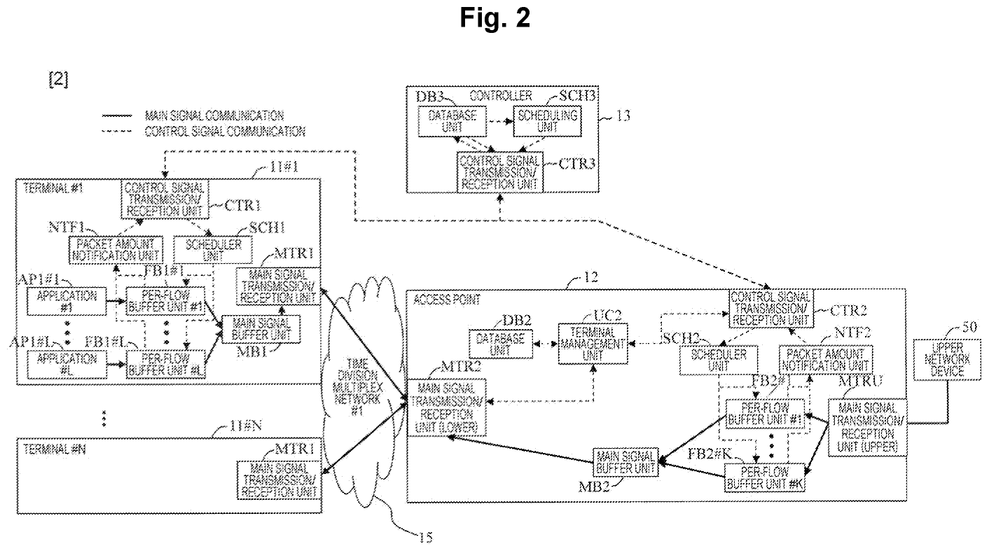

FIG. 2 is a diagram describing a control system of the present embodiment. The control system of the present embodiment includes N terminals 11, an access point 12 that communicates with these terminals 11, and a controller 13 that allocates a communication band of the terminals 11. The terminals 11, the access point 12, and the controller 13 can also be implemented with a computer and a program, and the program can be recorded on a recording medium or be provided through a network.

The terminals 11, the access point 12, and the controller 13 have a function of performing communication quality control of the terminals 11 on the basis of a notification of packet amount from the terminals 11. Specifically, they have the configurations described below.

The terminal 11 includes a main signal transmission/reception unit MTR1, a main signal buffer unit MB1, per-flow buffers FB1 #1 to FB1 #L, applications AP1 #1 to AP1 #L, a scheduler unit SCH1, a packet amount notification unit NTF1, and a control signal transmission/reception unit CTR1.

The access point 12 includes a main signal transmission/reception unit (lower) MTR2, a main signal buffer unit MB2, per-flow buffer units FB2 #1 to FB2 #K, a main signal transmission/reception unit (upper) MTRU, a packet amount notification unit NTF2, a scheduler unit SCH2, and a control signal transmission/reception unit CTR2.

The controller 13 includes a database unit DB3, a scheduling unit SCH3, and a control signal transmission/reception unit CTR3.

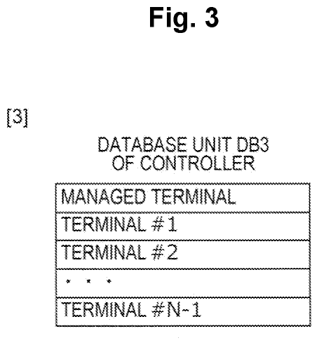

In the present embodiment, the controller 13 holds the number of the managed terminal. For example, it is assumed that terminals 11 #1 to 11 #N−1 are under the management of the controller, and terminals 11 #1 to 11 #N are connected to the access point 12. In this case, as illustrated in FIG. 3, the controller 13 holds a number of the managed terminal of the own device in the database DB3. The controller 13 transmits a number of the managed terminal held in the database unit DB3 to the access point 12 using a control signal. The control signal transmission/reception unit CTR2 receives this control signal. Thus, the controller 13 shares the information of the managed terminal with the access point 12.

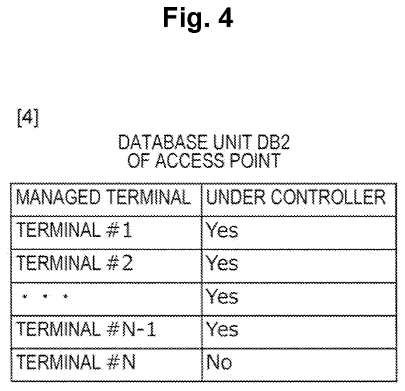

The access point 12 holds numbers of the terminals 11 to which the own device is connected. For example, as illustrated in FIG. 4, the access point 12 holds the numbers of the terminals 11 to which the own device is connected in a database DB2. In the present embodiment, the access point 12 holds information as to whether or not it is under the management of the controller 13, that is, whether or not it is a managed terminal, in association with the number of each terminal 11 held in the database DB2.

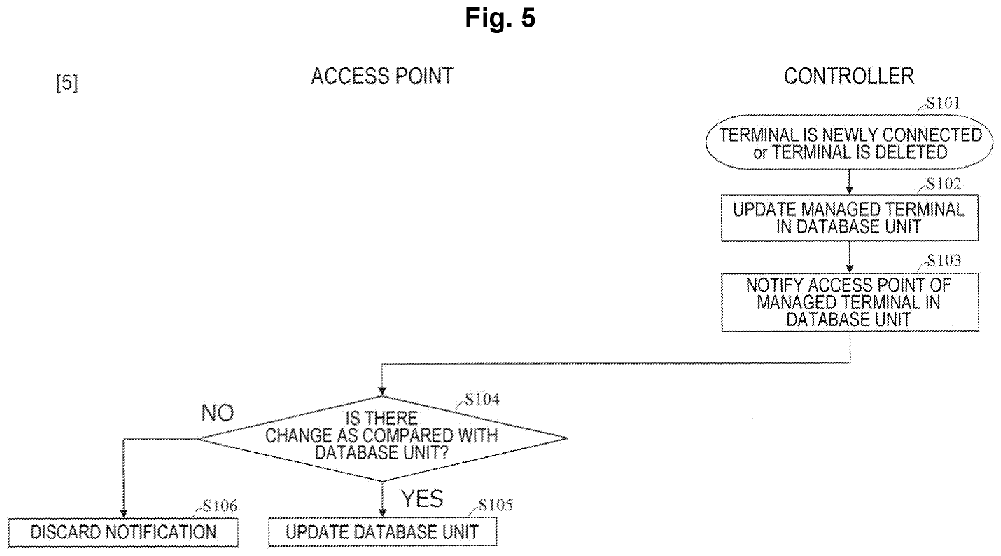

FIG. 5 illustrates an example of an operation of update of the database unit DB2 of the access point 12.

When a new terminal 11 is connected or the terminal 11 is deleted (S101), the controller 13 updates the managed terminal in the database unit DB3 (S102), and notifies the access point 12 of the managed terminal added or deleted in the database unit DB3 (S103).

The access point 12 compares the managed terminal a notification of which has been given, with the database unit DB2 to determine whether there is a change (S104).

When there is a change (Yes in S104), the database unit DB2 is updated (S105). On the other hand, when there is no change (No in S104), the notification is discarded (S106).

The access point 12 of the present embodiment has a configuration for not transmitting a transmission permission notification to the unmanaged terminal of the controller 13. For example, the access point 12 includes the database DB2 and a terminal management unit UC2.

The access point 12 holds the terminals 11 connected to the own device in the database unit DB2.

The terminal management unit UC2 of the access point 12 collates the number of the terminal 11 to which the main signal transmission/reception unit (lower) MTR2 transmits a transmission permission with the numbers of the terminals 11 held by the database unit DB2, and confirms whether the transmission destination of the transmission permission is an unmanaged terminal of the controller 13. When the transmission destination of the transmission permission is an unmanaged terminal of the controller 13, the terminal management unit UC2 of the access point 12 suppresses a transmission permission transmitted from the main signal transmission/reception unit (lower) MTR2.

As described above, the control system of the present embodiment can prevent packet collision in the wireless network 15 in order to prevent packet transmission from the terminal 11 out of management of the controller 13. Therefore, with the control system of the present embodiment, even when the terminal 11 out of management of the controller 13 is connected to the access point 12, appropriate communication quality control can be performed.

### Second Embodiment

The control system of the present embodiment includes a timing not used by the controller 13 in the control system described in the first embodiment. When a transmission request comes from the unmanaged terminal at that timing, the access point 12 returns the transmission permission to the unmanaged terminal. Thus, the present embodiment enables transmission permission also to the unmanaged terminal of the controller 13.

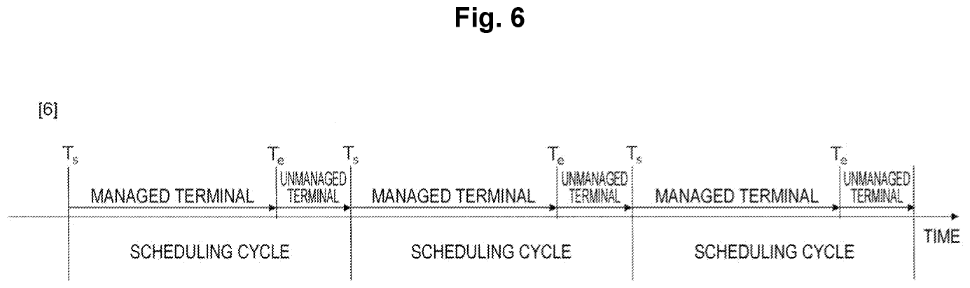

FIG. 6 illustrates an example of scheduling timing of the present embodiment. The controller 13 preliminarily sets a time to be allocated to the managed terminal and a time to be allocated to the unmanaged terminal in a scheduling cycle. In the present embodiment, the time allocated to the managed terminal in the scheduling cycle is referred to as an allocation time.

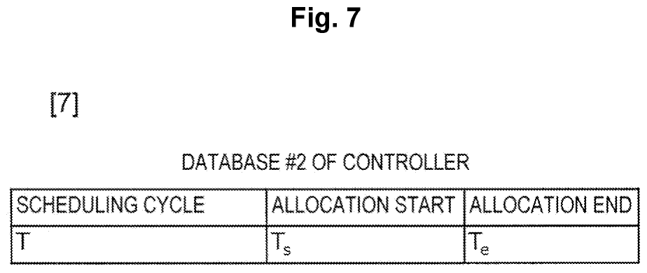

In the present embodiment, the controller 13 holds a scheduling cycle T, an allocation start time Tₛ in the allocation time, and an allocation end time Tₑ in the allocation time in the database DB3 as illustrated in FIG. 7 in addition to the numbers of the terminals 11 under the management of the controller 13 illustrated in FIG. 3. The controller 13 transmits the allocation time of the managed terminal held in the database unit DB3 to the access point 12 using a control signal.

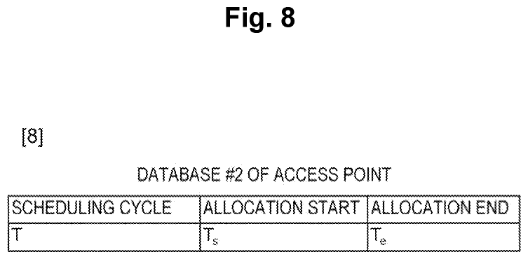

The control signal transmission/reception unit CTR2 of the access point 12 receives this control signal. As illustrated in FIG. 4, the database DB2 of the access point 12 holds the number of the terminal 11 to which the own device is connected and information as to whether it is a managed terminal. The terminal management unit UC2 of the access point 12 reads the managed terminal from the control signal received by the control signal transmission/reception unit CTR2, collates the managed terminal with the connected terminal held by the database unit DB2, and checks the unmanaged terminal of the controller 13. Further, in the present embodiment, as illustrated in FIG. 8, the scheduling cycle T, the allocation start time Tₛ, and the allocation end time Tₑ of the controller 13 are held in the database DB2.

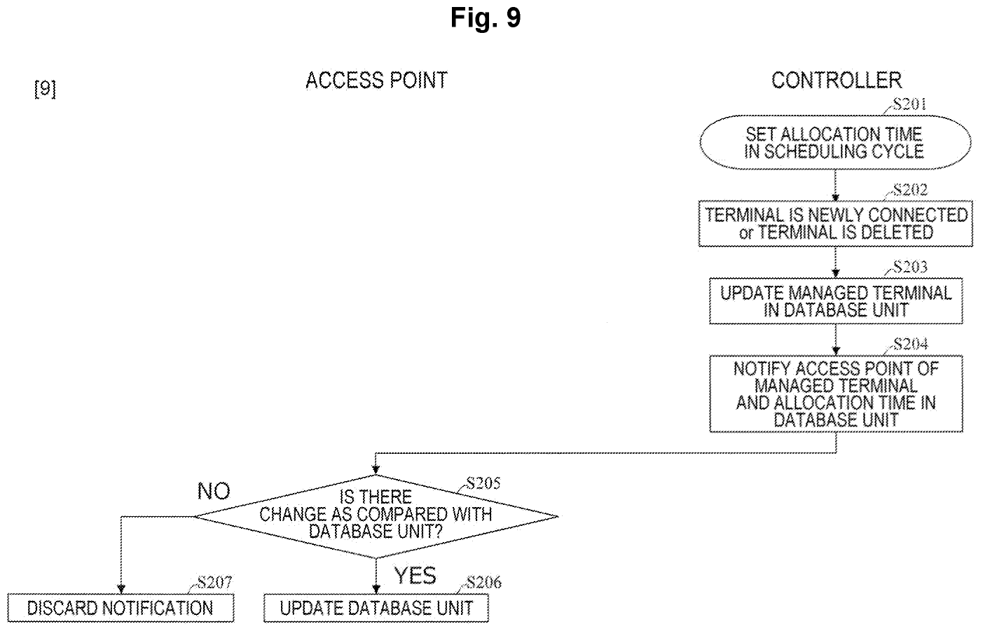

FIG. 9 illustrates an example of an operation of update of the database unit DB2 of the access point 12.

The controller 13 sets an allocation time within the scheduling cycle (S201).

When a new terminal 11 is connected or the terminal 11 is deleted (S202), the managed terminal is updated in the database unit DB3 (S203), and the access point 12 is notified of the managed terminal and the allocation time in the database unit DB3 (S204).

The access point 12 constantly grasps the terminals 11 connected to the own device. The access point 12 compares the managed terminal a notification of which has been given, with the database unit DB2 to determine whether there is a change (S205).

When there is a change (Yes in S205), the database unit DB2 is updated (S206). On the other hand, when there is no change (No in S205), the notification is discarded (S207).

In the present embodiment, the controller 13 performs scheduling of the packet amount a notification of which is periodically given, within the allocation time set above. The terminal management unit UC2 of the access point 12 does not transmit a transmission permission when a transmission request is made from the unmanaged terminal within the allocation time. The terminal management unit UC2 of the access point 12 transmits a transmission permission when a transmission request is made from the unmanaged terminal outside the allocation time.

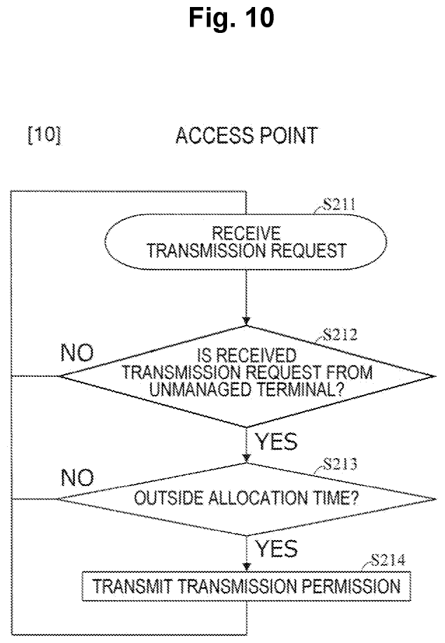

FIG. 10 illustrates an example of an operation when there is a transmission request from the terminal 11 to the access point 12. When the transmission request is received (S211), it is determined whether the received transmission request is from the unmanaged terminal with reference to the database unit DB2 (S212).

In addition, it is determined whether the received transmission request is outside the allocation time from the allocation start time Tₛ to the allocation end time Tₑ (S213).

In the case of an unmanaged terminal (Yes in S212) and it is outside the allocation time from Tₛ to Tₑ (Yes in S213), a transmission permission is transmitted to the terminal 11, which is a transmission source of the transmission request (S214).

### Third Embodiment

The controller 13 illustrated in FIG. 2 described in the first and second embodiments allocates the transmission time of each terminal 11 on the basis of the notification of the packet amount from the terminal 11, and each terminal 11 transmits and receives the packet according to the allocation of the controller 13. In the present embodiment, an example in which the controller 13 allocates the transmission time and the transmission amount will be specifically described.

Each of the terminal 11 and the access point 12 includes:
a buffer (FB1, FB2) that accumulates transmission packets for each traffic flow;
a device-side transmission/reception unit (CTR1, CTR2) that transmits an accumulation amount of the transmission packet for each traffic flow accumulated in the buffer (FB1, FB2) to the controller 13 and receives a transmission time and a transmission amount of the transmission packet for each traffic flow from the controller 13; and
a main signal transmission unit (MTR1, MTR2) that transmits the transmission packet for each traffic flow in the buffer (FB1, FB2) to the wireless network 15 according to the transmission time and the transmission amount.

The controller 13 includes:
the control-side transmission/reception unit CTR3 that receives the accumulation amount from each of the terminal 11 and the access point 12 and transmits the transmission time and the transmission amount to each of the terminal 11 and the access point 12; and
the scheduling unit SCH3 that determines the transmission time and the transmission amount of the transmission packet for each traffic flow on the basis of the accumulation amount.

The control system of the present embodiment communicates a control signal between the controller 13 and the access point 12/terminal 11 using a communication means different from a communication means for a main signal (packet of traffic). Specifically, the control signal is transmitted and received between the control signal transmission/reception unit CTR1 of the terminal 11 and the control signal transmission/reception unit CTR3 of the controller 13, and between the control signal transmission/reception unit CTR2 of the access point 12 and the control signal transmission/reception unit CTR3 of the controller 13.

Each terminal 11 and the access point 12 periodically notify the controller 13 of the packet amounts accumulated in the per-flow buffer units (FB1 and FB2) as a control signal.

The terminal 11 accumulates the packet from each application AP1 in the buffer FB1 for each application (for each flow). The packet amount notification unit NTF1 periodically checks the packet accumulation amount of each buffer FB1 and notifies the controller 13 of it as a control signal via the control signal transmission/reception unit CTR1.

In addition, the access point 12 accumulates packets from an upper network device 50 in the buffer FB2 for each application (for each flow). The packet amount notification unit NTF2 periodically checks the packet accumulation amount of each buffer FB2 and notifies the controller 13 of it as a control signal via the control signal transmission/reception unit CTR2.

Note that the per-flow buffer unit FB1 may be owned by the application AP1.

The controller 13 records the packet accumulation amount a notification of which has been given, and information of the terminals 11, the access point 12, and the per-flow buffers (FB1 and FB2), determines a transmission time and a transmission amount for each buffer on the basis of the above, and notifies each terminal 11 and the access point 12 of it as a control signal.

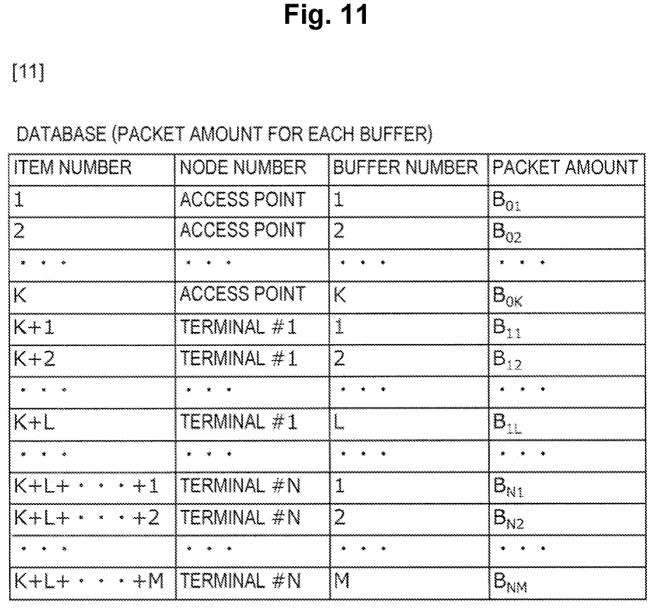

The control signal transmission/reception unit CTR3 of the controller 13 receives the control signal from each terminal 11 and the access point 12, and organizes the information included in the control signal in the database DB3. For example, as illustrated in FIG. 11, the controller 13 organizes the packet accumulation amount of the terminal 11, and the information of the terminal 11, the access point 12, and the per-flow buffers (FB1 and FB2) in the database DB3.

FIG. 11 is a diagram describing an example of information organized in the database DB3.

The present database DB3 organizes the three pieces of information described below.

The item number is a serial number for all the buffers (FB1 and FB2) of the terminal 11 and the access point 12.

The node number is a number of the access point 12 or the terminal 11.

The buffer number is a number of the buffer FB1 held by each terminal 11 or a number of the buffer FB2 held by the access point 12.

The packet amount is a packet accumulation amount held by the buffer having its buffer number. For example, the item number K+2 is a packet accumulation amount of a per-flow buffer unit FB1 #2 included in a terminal 11 #1, meaning that the amount thereof is “B12”.

The scheduling unit SCH3 of the controller 13 determines the transmission time and the transmission amount for each buffer from the content of the database unit DB3 using a scheduling method to be described below. Then, the scheduling unit SCH3 uses the determined transmission time and transmission amount as a control signal, and transmits the control signal to the terminal 11 and the access point 12 from the control signal transmission/reception unit CTR3.

Each terminal 11 and the access point 12 extract a packet accumulated in the per-flow buffer unit (FB1, FB2) at the transmission time and transmission amount a notification of which has been given, and inputs the packet to the main signal buffer unit (MB1, MB2). The main signal transmission/reception unit (MTR1, MTR2) transmits a packet of the main signal buffer unit (MB1, MB2) to the wireless network 15.

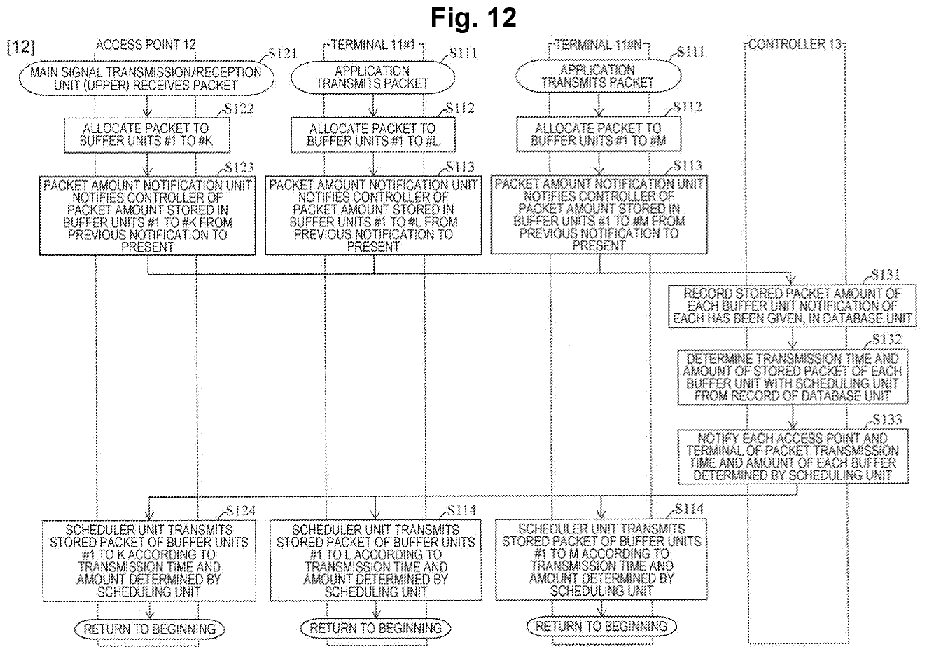

FIG. 12 is a diagram describing the operation described above by flowchart. A control method of the present embodiment is a control method for controlling traffic of the wireless network 15, and the control method is transmission control performed by the controller 13 with respect to the terminal 11 and the access point 12 that mutually transmit a packet via the wireless network 15, the control method including:
accumulating a transmission packet for each traffic flow in respective buffers (FB1 and FB2) of the terminal 11 and the access point 12 (steps S111, S112, S121, and S122);
transmitting an accumulation amount of the transmission packet for each traffic flow accumulated in each of the buffers to the controller (steps S113 and S123);
determining, by the controller, a transmission time and a transmission amount of the transmission packet for each traffic flow on the basis of the accumulation amount received from each of the terminal and the access point (steps S131 and S132);
transmitting the transmission time and the transmission amount from the controller to each of the terminal and the access point (step S133); and
transmitting the transmission packet for each traffic flow from the buffers of the terminal and the access point to the wireless network according to the transmission time and the transmission amount (steps S114 and S124).

### [Scheduling Method]

Here, a scheduling method performed by a scheduling unit SCH13 of the controller 13 will be described.

### [1] Fair Scheduling

In the present scheduling method, calculation of dividing a band or time by the total number of per-flow buffers in which packets are accumulated among the per-flow buffers (FB1 and FB2) of the terminal 11 and the access point 12 is performed.

The parameters will be described below.

Number of per-flow buffers in which packets are accumulated in a combination of the terminal 11 and the access point 12: n

Time of 1 cycle: T[sec]

Total main signal transmission limit per cycle time: Z[Bytes/sec]

Time to transmit first accumulated packet: tₛₜₐᵣₜ [sec]

In this case,
a transmission amount S_{J}[Bytes] of a per-flow buffer #J is calculated to be

$$\begin{matrix}[ Math . 1 ] & \\ {S}_{J} = \frac{Z}{n} , & ( 1 )\end{matrix}$$

a transmission time T_{J}[sec] of a per-flow buffer #J is calculated to be

$$\begin{matrix}[ Math . 2 ] & \\ {T}_{J} = \frac{T}{n} , & ( 2 )\end{matrix}$$

a transmission time t_{J}[sec] of a per-flow buffer #J is calculated to be

[Math. 3]

t_{J}=tₛₜₐᵣₜ+Σ_{J=1}T_{J-1} (3).

Note that it is conceivable that the order of the per-flow buffers to start transmission is, for example, that transmission is performed from a smaller number of item numbers organized in the database unit DB3 of the controller 13.

### [2] Scheduling in Consideration of Band Weighting

The present scheduling method is determined by the number of per-flow buffers in which packets are accumulated among the per-flow buffers (FB1 and FB2) of the terminal 11 and the access point 12 and the packet accumulation amount.

The parameters will be described below.

Packet accumulation amount of per-flow buffer #J: B_{J}[Bytes]

Time of 1 cycle: T[sec]

Transmission limit per cycle time: Z[Bytes/sec]

Time required to transmit all packets accumulated in all per-flow buffers: Tau[sec]

Time of first packet transmission among packets accumulated in all per-flow buffers: tₛₜₐᵣₜ[sec]

When this case is

$$\begin{matrix}[ Math . 4 ] & \\ {T}_{all} = \frac{{\sum }_{J = 1} {B}_{J}}{Z} , & ( 4 )\end{matrix}$$

a transmission amount S_{J}[Bytes] of a per-flow buffer #J is calculated to be,
in the case of Tₐₗₗ≤T,

[Math. 5a]

S_{J}=B_{J} (5a),
and
in the case of Tₐₗₗ>T,

$$\begin{matrix}[ Math . 5 b ] & \\ {S}_{J} = \frac{T}{{T}_{all}} {B}_{J} , & ( 5 b )\end{matrix}$$

a transmission time T_{J}[sec] of a per-flow buffer #J is calculated to be,
in the case of Tₐₗₗ≤T,

$$\begin{matrix}[ Math . 6 a ] & \\ {T}_{J} = \frac{{S}_{J}}{{\sum }_{J = 1} {B}_{J}} {T}_{all} , and & ( 6 a )\end{matrix}$$

in the case of Tₐₗₗ>T,

$$\begin{matrix}[ Math . 6 b ] & \\ {T}_{J} = \frac{{S}_{J}}{{\sum }_{J = 1} {B}_{J}} {T}_{all} , & ( 6 b )\end{matrix}$$

and
a transmission time t_{J}[sec] of a per-flow buffer #J is calculated to be,
in the case of Tₐₗₗ≤T,

[Math. 7a]

t_{J}=tₛₜₐᵣₜ+Σ_{J=1}T_{J-1} (7a),
and
in the case of Tₐₗₗ>T,

[Math. 7b]

t_{J}=tₛₜₐᵣₜ+Σ_{J=1}T_{J-1} (7b).

Note that in the case of Tₐₗₗ>T, the packet that cannot be transmitted is carried forward to the next transmission timing. In addition, in the present embodiment, an example in which the controller 13 allocates the transmission time and the transmission amount as an example of the communication band to be allocated to each terminal 11 is described, but the present disclosure is not limited thereto.

### INDUSTRIAL APPLICABILITY

The present disclosure can be applied to information and communication industries.

### REFERENCE SIGNS LIST

11 Terminal
12 Access point
13 Controller
15 Wireless network
50 Upper network device
300 Control system

1. A control system for controlling traffic of a wireless network, the control system comprising:
a terminal and an access point that mutually transmit a packet via the wireless network; and
a controller that performs transmission control with respect to the terminal and the access point, wherein
the controller notifies the access point of information of a terminal under management of own device, and
the access point
collates information of the terminal a notification of which has been given with information of a terminal connected to the own device, and
suppresses notification of transmission permission to an unmanaged terminal different from a terminal under management of the controller.

2. The control system according to claim 1, wherein
the controller further notifies the access point of a scheduling cycle at which the own device allocates a transmission band to the terminal, an allocation start time, and an allocation end time, and
the access point performs transmission permission to the unmanaged terminal in a time zone excluding a time from the allocation start time to the allocation end time within the scheduling cycle.

3. A control method for controlling traffic of a wireless network,
the control method being transmission control performed by a controller with respect to a terminal and an access point that mutually transmit a packet via the wireless network, wherein
the controller notifies the access point of information of a terminal under management of own device, and
the access point
collates information of the terminal a notification of which has been given with information of a terminal connected to the own device, and
suppresses notification of transmission permission to an unmanaged terminal different from a terminal under management of the controller.

4. A controller for controlling traffic of a wireless network,
the controller being a device that performs transmission control with respect to a terminal and an access point that mutually transmit a packet via the wireless network, wherein
the controller notifies the access point of information of a terminal under management of own device, and
causes the access point to suppress notification of transmission permission to an unmanaged terminal different from a terminal under management of the controller.

5. A non-transitory computer-readable medium having computer-executable instructions that, upon execution of the instructions by a processor of a computer, cause the computer to function as the controller according to claim 4.
